(19) United States
(12) Patent Application Publication
(10) Pub. No.: US 2003/0072292 A1
(43) Pub. Date: Apr. 17, 2003

(54) Transmitting/receiving apparatus and method for packet retransmission in a mobile communication system

(75) Inventors: Jae-Seung Yoon, Songnam-shi (KR); Yong-Suk Moon, Songnam-shi (KR); Jun-Sung Lee, Suwon-shi (KR); Chul-Hong Boo, Sogwipo-shi (KR); Noh-Sun Kim, Taajon-kwangyokshi (KR); Hun-Kee Kim, Seoul (KR)

Correspondence Address: Paul J. Fareell, Esq., DILWORTH & BARRESE, LLP, 333 Earle Ovington Blvd., Uniondale, NY, 11553, US

(73) Assignee: SAMSUNG ELECTRONICS CO., LTD, KYUNGKI-DO (KR)

(21) Appl. No.: 10/273,096

(22) Filed: Oct. 17, 2002

(30) Foreign Application Priority Data
Oct. 17, 2001 (KR) P2001-64114

(51) Int. Cl. H04B 7/216

(52) U.S. Cl. 370/342; 370/441

(57) ABSTRACT

Disclosed is a transmitting/receiving apparatus for packet retransmission in a mobile communication system. Upon a retransmission request by a receiver, a transmitter rearranges coded bits and maps the rearranged bits to modulation symbols. The modulation symbols of a retransmission are transmitted with different reliabilities from those of an initial transmission. A receiver demodulates received data and rearranges the coded bits in an original order before decoding if the coded bits have been retransmitted.

### PRIORITY

This application claims priority to an application entitled “Transmitting/Receiving Apparatus and Method for Packet Retransmission in a Mobile Communication System” filed in the Korean Industrial Property Office on Oct. 17, 2001 and assigned Serial No. 2001-64114, the contents of which are hereby incorporated by reference.

### BACKGROUND OF THE INVENTION

1. Field of the Invention

The present invention relates generally to a WCDMA (Wideband Code Division Multiple Access) mobile communication system, and in particular, to a transmitting/receiving apparatus and method for improving decoding performance at retransmission.

2. Description of the Related Art

Adverse influences on high-speed, high-quality data services are attributed to a radio channel environment in a mobile communication system. The radio channel environment varies frequently because of white noise, fading-incurred signal power changes, shadowing, the Doppler effect that occurs due to the movement and frequent velocity changes of a terminal, and interference from other users and multi-path signals. Therefore, aside from conventional technologies in the second or third generation mobile communication systems, a highly adaptive advanced technique to channel environmental changes is required to support wireless high-speed data packet services. In this context, the 3GPP (3^{rd} Generation Partnership Project) and the 3GPP2 commonly address the techniques of AMCS (Adaptive Modulation & Coding Scheme) and HARQ (Hybrid Automatic Repeat Request).

AMCS adjusts a modulation order and a coding rate according to changes in downlink channel condition. The downlink channel quality is usually evaluated by measuring the SNR (Signal-to-Noise Ratio) of a received downlink signal at a UE (User Equipment). The UE feeds back the channel quality information to a BS (Base Station) on an uplink. Then the BS estimates the downlink channel condition based on the channel quality information and determines an appropriate modulation scheme and coding rate for a channel encoder according to the downlink channel condition estimate.

Regarding HARQ, there are challenging issues needing consideration in terms of channel quality and system complexity including reception buffer size and signaling.

QPSK (Quadrature Phase Shift Keying), 8PSK (8-ary PSK), and 16QAM (16-ary Quadrature Amplitude Modulation) and coding rates of ½ and ¼ are under consideration for use in a high-speed wireless data packet communication system. In AMCS, a BS applies a high-order modulation (e.g., 16QAM and 64QAM) and a high coding rate (e.g., ¾) to a UE having good channel quality, such as its adjacent UEs, and applies a low-order modulation (e.g., 8PSK and QPSK) and a low coding rate (e.g., ½) to a UE having bad channel quality, such as a UE at a cell boundary. Thus AMCS remarkably reduces interference signals and improves system performance on the whole, as compared with a conventional method relying on fast power control.

HARQ is a retransmission control technique to correct errors in initially transmitted data packets. Schemes for implementing HARQ include chase combining (CC), full incremental redundancy (FIR), and partial incremental redundancy (PIR).

With CC, an entire initial transmission packet, including systematic bits, and parity bits is retransmitted. A receiver combines the retransmission packet with the initial transmission packet stored in a reception buffer. The resulting increase of the transmission reliability of coded bits input to a decoder results in a performance gain of the overall mobile communication system. 3-dB performance gain is realized on the average since combining of the same two packets is equivalentto repeated coding of the packet.

In FIR, a packet having only parity bits, different from an initial transmission packet is retransmitted to thereby increase a decoding gain. A decoder decodes data using the new parity bits as well as initially transmitted systematic and parity bits. As a result, decoding performance is improved. It is well known in coding theory that a greater performance gain is achieved at a lower coding rate, rather than by repeated coding. Therefore, FIR is superior to CC in terms of performance gain.

As compared with FIR, PIR is another retransmission scheme in which a packet having systematic bits and new parity bits is retransmitted. A receiver combines the retransmitted systematic bits with initially transmitted systematic bits for decoding, achieving similar effects to those of CC. PIR is also similar to FIR in that the new parity bits are used for decoding. Since PIR is implemented at a coding rate higher than FIR, PIR's performance improvement is between FIR and CC schemes.

A combined use of the independent techniques of increasing adaptability to varying channel condition, AMCS and HARQ can improve system performance significantly.

FIG. 1 is a block diagram of a transmitter in a typical high-speed wireless data packet communication system. Referring to FIG. 1, the transmitter includes a channel encoder 110, a rate controller 120, an interleaver 130, a modulator 140, and a controller 150.

Upon input of information bits in transport blocks of size N, the channel encoder 10 encodes the information bits at a coding rate R (=n/k, n is prime to k.), for example, ½ or ¾. With the coding rate R, the channel encoder 110 outputs n coded bits for the input of k information bits. The channel encoder 110 can support a plurality of coding rates using a mother coding rate of ⅙ or ⅕ through symbol puncturing or symbol repetition. The controller 150 controls the coding rate.

The rate controller 120 matches the data rate of the coded bits by transport channel-multiplexing, or by repetition and puncturing if the number of the coded bits is different from that of bits transmitted in the air. To minimize data loss caused by burst errors, the interleaver 130 interleaves the rate-matched bits. The modulator 140 modulates the interleaved bits in a modulation scheme determined by the controller 150.

The controller 150 selects the coding rate and the modulation scheme according to the radio downlink channel condition. To selectively use QPSK, 8PSK, 16QAM, and 64QAM according to the radio environment, the controller 150 supports AMCS.

Though not shown, a UE spreads the modulated data with a plurality of Walsh codes to identify data transport channels, and with a PN (Pseudo random Noise) code to identify a BS.

As stated before, the modulator 140 supports various modulation schemes including QPSK, 8PSK, 16QAM and 64QAM with respect to the interleaved bits. As a modulation order increases, the number of bits in one modulation symbol increases. Particularly in higher-order modulation schemes other than 8PSK, one modulation symbol includes three or more bits. In this case, bits mapped to one modulation symbol have different transmission reliabilities according to their positions.

With regard to transmission reliability, two bits of a modulation symbol representing a macro region defined by left/right and up/down have a relatively high reliability in an I (In Phase)-Q (Quadrature Phase) signal constellation. The other bits representing a micro region within the macro region have a relatively low reliability.

FIG. 2 illustrates an exemplary signal constellation in 16QAM. Referring to FIG. 2, one 16QAM modulation symbol contains 4 bits [i1, q1, i2, q2] in a reliability pattern [H, H, L, L] (H denotes high reliability and L denotes low reliability). That is, the two upper 2 bits [i1, q1] have a relatively high reliability, and the two lower 2 bits [i2, q2], a relatively low reliability.

FIG. 3 illustrates an exemplary signal constellation in 64QAM. Referring to FIG. 3, one 64QAM modulation symbol contains 6 bits [i1, q1, i2, q2, i3, q3] in a reliability pattern [H, H, M, M, L, L] (M denotes medium reliability).

Similarly, an 8PSK modulation symbol contains 3 bits. One of them has a lower reliability than the other two bits. Thus, a reliability pattern is [H, H, L].

In conventional HARQ, however, initial transmission bits and their retransmission bits are the same in reliability. Bits mapped to a low reliability position still have the low reliability at retransmission and the same occurs to bits mapped to a high reliability.

It is known that when the LLRs (Log Likelihood Ratios) of input bits are uniform, decoding performance is improved in turbo coding. Yet continuous transmission of bits in the same environment may deteriorate decoding performance. In this context, there is a need for exploring a novel retransmission scheme with improved transmission performance.

### SUMMARY OF THE INVENTION

It is, therefore, an object of the present invention to provide a transmitting/receiving apparatus and method in which packet retransmission is carried out with increased system performance in a wireless communication system.

It is another object of the present invention to provide an apparatus and method for transmitting bits with higher reliability in a wireless communication system.

It is also another object of the present invention to provide an apparatus and method for receiving bits with higher reliability in a wireless communication system.

It is a further object of the present invention to provide a transmitting/receiving apparatus and method for providing more efficient packet retransmission in a wireless communication system supporting HARQ.

It is also a further object of the present invention to provide an apparatus and method for rearranging the coded bits of a modulation symbol for retransmission in order to have a different reliability from that at an initial transmission.

It is still another object of the present invention to provide an apparatus and method for recovering retransmission code symbols rearranged to have a different reliability from that at an initial transmission.

It is also still another object of the present invention to provide an apparatus and method for rearranging coded bits mapped to a retransmission modulation symbol to be transmitted via a different orthogonal channel from that at an initial transmission.

It is yet another object of the present invention to provide an apparatus and method for recovering retransmission coded bits that are rearranged to be transmitted via a different orthogonal channel from that at an initial transmission.

To achieve the above and other objects, according to an aspect of the present invention, coded bits are rearranged in a predetermined rearrangement pattern upon request of a receiver for retransmission. The rearranged bits are mapped to modulation symbols and transmitted to the receiver.

According to another aspect of the present invention, in a transmitter, a bit rearranger rearranges coded bits in a predetermined rearrangement pattern upon request of a receiver for retransmission and a modulator maps the rearranged bits to modulation symbols.

According to a further aspect of the present invention, data received for a transmitted retransmission request is demodulated and coded bits are output. The coded bits are rearranged in a predetermined rearrangement pattern corresponding to a rearrangement pattern used in a transmitter and decoded.

According to still another aspect of the present invention, in a receiver, a demodulator demodulates data received for a transmitted retransmission request and outputs coded bits. A bit rearranger rearranges the coded bits in a predetermined rearrangement pattern corresponding to a rearrangement pattern used in the transmitter, and a channel decoder decodes the rearranged coded bits.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter in a conventional CDMA mobile communication system;

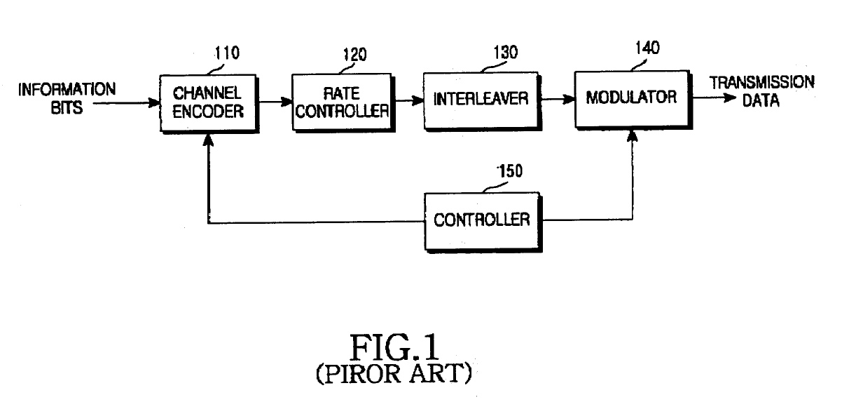

FIG. 2 illustrates an example of a signal constellation in 16QAM in a CDMA mobile communication system;

FIG. 3 illustrates an example of a signal constellation in 64 QAM in the CDMA mobile communication system;

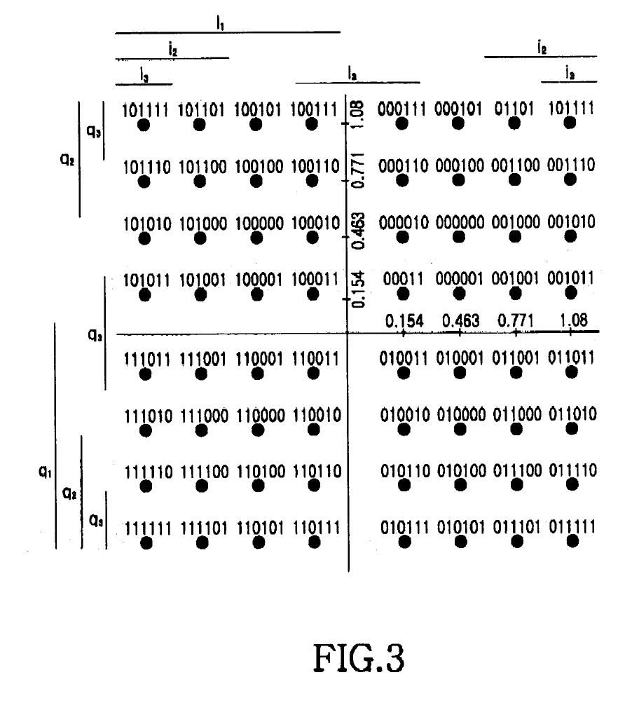

FIG. 4 is a block diagram of a transmitter in a CDMA mobile communication system according to an embodiment of the present invention;

FIG. 5 is a detailed block diagram of a channel encoder illustrated in FIG. 4;

FIG. 6 is a flowchart illustrating the operation of the transmitter in the CDMA mobile communication system according to an embodiment of the present invention;

FIG. 7 is a block diagram of a receiver being the counterpart of the transmitter illustrated in FIG. 4 in the CDMA mobile communication system according to an embodiment of the present invention;

FIG. 8 is a flowchart illustrating the operation of the receiver in the CDMA mobile communication system according to an embodiment of the present invention;

FIG. 9 illustrates bit rearrangement in the transmitter when 16QAM is used according to an embodiment of the present invention;

FIG. 10 illustrates bit rearrangement in the transmitter when 64QAM is used according to an embodiment of the present invention;

FIG. 11 illustrates bit rearrangement in the transmitter when 8PSK is used according to an embodiment of the present invention; and

FIG. 12 illustrates bit rearrangement at a first retransmission in the transmitter when 16QAM is used according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

HARQ considered in the present invention is a link controlling technique for correcting packet errors by retransmission. As is applied retransmission is a repeat transmission of initially transmitted, but failed, packet data. Therefore, new data is not transmitted at a retransmission.

As described before, HARQ techniques are divided into HARQ type II and HARQ type III depending on whether or not systematic bits and parity bits are retransmitted. The major HARQ type II is FIR, and HARQ type III includes CC and PIR that are discriminated according to whether the same parity bits are retransmitted.

The present invention as described below is applied to any of the above HARQ techniques. In CC, a retransmission packet has the same bits as an initial transmission packet, and in FIR and PIR a retransmission packet and an initial transmission packet have different bits. The following description is made of the respective HARQ techniques.

Transmission

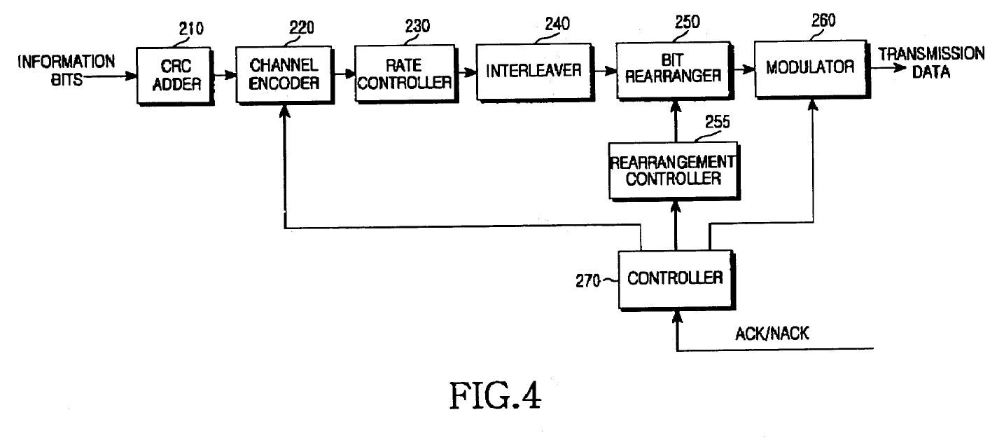

FIG. 4 is a block diagram of a transmitter in a CDMA mobile communication system according to an embodiment of the present invention. Referring to FIG. 4, the transmitter includes a CRC (Cyclic Redundancy Check) adder 210, a channel encoder 220, a rate controller 230, an interleaver 240, a bit rearranger 250, a rearrangement controller 255, a modulator 260, and a controller 270. In the embodiment of the present invention, coded bits are rearranged at retransmission to be mapped to different symbols from those at an initial transmission.

The CRC adder 210 adds CRC bits to input information bits on a packet data basis for an error check. The channel encoder 220 encodes at a predetermined coding rate by predetermined coding the packet data with the CRC bits.

The packet data is encoded to systematic bits and parity bits, the parity bits being error control bits for the systematic bits. Turbo coding or convolutional coding can be used.

The coding rate determines the ratio of the parity bits to the systematic bits. With a coding rate of ½, for example, the channel encoder 220 outputs one systematic bit and one parity bit for the input of one information bit. With a coding rate of ¾, the channel encoder 220 outputs three systematic bits and one parity bit for the input of three information bits. In the embodiment of the present invention, other coding rates can also be applied aside from ½ and ¾.

The rate controller 230 matches the data rate of the coded bits to the required output by repetition and puncturing. The interleaver 240 randomly permutes the sequence of the rate-matched bits. The interleaved symbols are stored in a buffer (not shown) for retransmission. In CC, the same packet stored in the transmission buffer is output under the control of the controller 270 upon request of a receiver for a retransmission.

The bit rearranger 250 rearranges the interleaved bits of a modulation symbol under the control of the rearrangement controller 255. The rearrangement controller 255 activates the bit rearranger 250 depending on whether the current transmission is an initial transmission or a retransmission. At an initial transmission, the bit rearranger 250 under the control of the rearrangement controller 255 simply outputs the interleaved bits without rearrangement. At a retransmission, under the control of the rearrangement controller 225 the bit rearranger 250 rearranges the interleaved bits of each modulation symbol.

Thus by rearranging the coded bits to be mapped the bit rearranger 250 creates a mapping that has a different error probability at a retransmission than the error probability at an initial transmission. The bit rearranger 250 is applicable to any of CC, PIR and FIR, which will be described later in more detail.

The modulator 260 modulates input coded bits in a predetermined modulation scheme.

The controller 270 provides overall control to the components of the transmitter. The controller 270 first determines the coding rate of the channel encoder 220 and the modulation scheme of the modulator 260 according to the current radio channel condition. The controller 270 also processes a retransmission request from an upper layer and feeds the retransmission request information to the rearrangement controller 255. The retransmission request information indicates whether the receiver has requested a packet retransmission and how many times retransmission has been carried out.

It can be further contemplated that the rearrangement controller 255 is integrated into the controller 270. In this case, the integrated controller determines the coding rate and modulation scheme and whether to activate the bit rearranger 250 according to signaling from the upper layer.

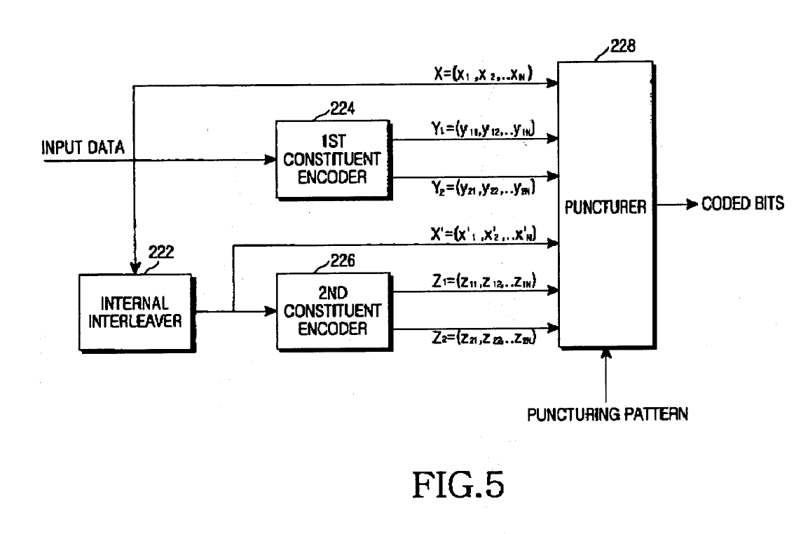

FIG. 5 is a detailed block diagram of the channel encoder 220 illustrated in FIG. 4. It is assumed that the channel encoder 220 uses a mother coding rate of ⅙ provided from the 3GPP (3^{rd} Generation Partnership Project) standards.

Referring to FIG. 5, the channel encoder 220 outputs one data frame of size N as a systematic bit frame X (=x₁, x₂, . . . , x_{N}). Here, N is determined according to the coding rate. A first constituent encoder 224 outputs two different parity bit frames Y1 (=Y₁₁, Y₁₂, . . . , Y_{1N}) and Y2 (=Y₂₁, Y₂₂, . . . , Y_{2N}) associated with each input data frame.

An internal interleaver 222 interleaves the data frame and outputs it as an interleaved systematic bit frame X′ (=x′₁, X′₂ , . . ., X′_{N}). A second constituent encoder 226 encodes the interleaved systematic bit frame X′ to two different parity bit frames Z1 (=z₁₁, Z₁₂, . . . , Z_{1N}) and Z2 (=Z₂₁, Z₂₂, . . . , Z_{2N}).

A puncturer 228 generates intended systematic bits S and parity bits P by puncturing the systematic bit frame X, the interleaved systematic bit frame X′, and the parity bit frames Y1, Y2, Z1 and Z2 in a puncturing pattern received from the controller 270.

The puncturing pattern is determined according to the coding rate of the channel encoder 220 and the HARQ technique used by the system. For example, when the coding rate is ½, puncturing patterns available in HARQ type III (CC and PIR) are as follows:

$$\begin{matrix}{P}_{1} = [ \begin{matrix}1 & 1 \\ 1 & 0 \\ 0 & 0 \\ 0 & 0 \\ 0 & 0 \\ 0 & 1\end{matrix} ] & ( 1 ) \\ {P}_{2} = [ \begin{matrix}1 & 1 \\ 1 & 0 \\ 0 & 0 \\ 0 & 0 \\ 0 & 1 \\ 0 & 0\end{matrix} ] & ( 2 )\end{matrix}$$

where 1 means to transmit a bit and 0 means to puncture a bit. Input bits are punctured from the left column to the right column.

One of the above puncturing patterns is used at an initial transmission and retransmissions in CC, while they are alternately used at each transmission in PIR.

In HARQ type II (FIR), systematic bits are punctured at a retransmission. In this case, a puncturing pattern is “010010”, for example.

In CC, if the puncturing pattern PI (i.e., “110000” and “100001”) is used, the puncturer 228 outputs bits X, Y1, X and Z2 with the other bits punctured at each transmission. If the puncturing pattern P2 (i.e., “110000” and “100010”) is used, the puncturer 228 outputs bits X, Y1, X and Z with the other bits punctured at each transmission.

In PIR, the puncturer 228 outputs bits X, Y1, X and Z2 in the puncturing pattern of “100001” at an initial transmission and bits X, Y1, X and Z1 in the puncturing pattern of “100010” at a retransmission.

While the channel encoder 220 uses a mother coding rate of ⅙, a channel encoder using a mother coding rate of ⅓as adopted in the 3GPP can be similarly realized using one constituent encoder and one puncturer. The puncturer outputs coded bits including systematic bits S and parity bits P by puncturing a systematic bit frame X and parity bit frames Y1 and Y2.

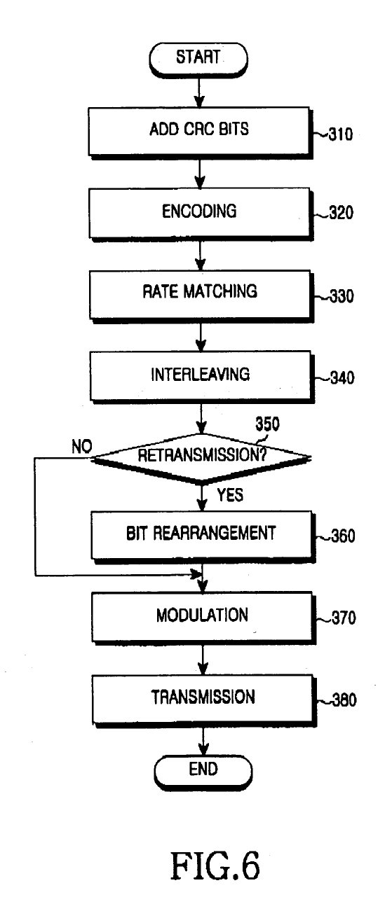

FIG. 6 is a flowchart illustrating the operation of the transmitter according to the embodiment of the present invention. Referring to FIG. 6, the CRC adder 210 adds CRC bits to input data on a packet basis in step 310 and the channel encoder 220 encodes the packet data with the CRC bits in step 320. In step 330, the rate controller 230 matches the rate of the coded bits by repetition and puncturing. The interleaver 240 interleaves the rate-matched bits in step 340.

The rearrangement controller 255 determines in step 350 whether the packet is to be initially transmitted or retransmitted according to a retransmission request received from the controller 270. In the case of initial transmission, i.e. a “no” response in step 350, the rearrangement controller 255 causes the interleaved bits to bypass the bit rearranger 250 and feeds the unrearranged interleaved bits to the modulator 260. Then the modulator 260 modulates the interleaved bits in step 370 and the modulated bits are transmitted in step 380.

On the other hand, in the case of retransmission, i.e., a “yes” response in step 350, the rearrangement controller 255 rearranges in step 360 the interleaved bits on a modulation symbol basis according to a predetermined rearrangement pattern. Then the modulator 260 modulates the rearranged bits in step 370 and the modulated bits are transmitted in step 380.

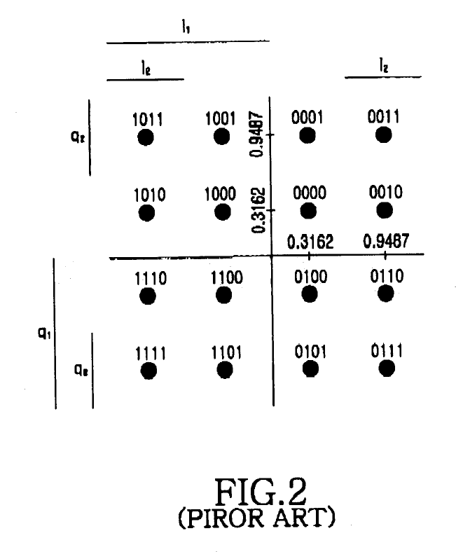

In 16QAM having a reliability pattern [H, H, L, L] as illustrated in FIG. 2, the upper two bits “ab” of a modulation symbol for an initial transmission “abcd” are mapped to have a high reliability, and the lower two bits “cd” are mapped to have a low reliability. If a rearranged modulation symbol is “acbd”, the upper two bits “ac” are mapped to have a high reliability, and the lower two bits “bd”, to have a low reliability. Other embodiments of bit rearrangement will be described later in more detail.

Reception

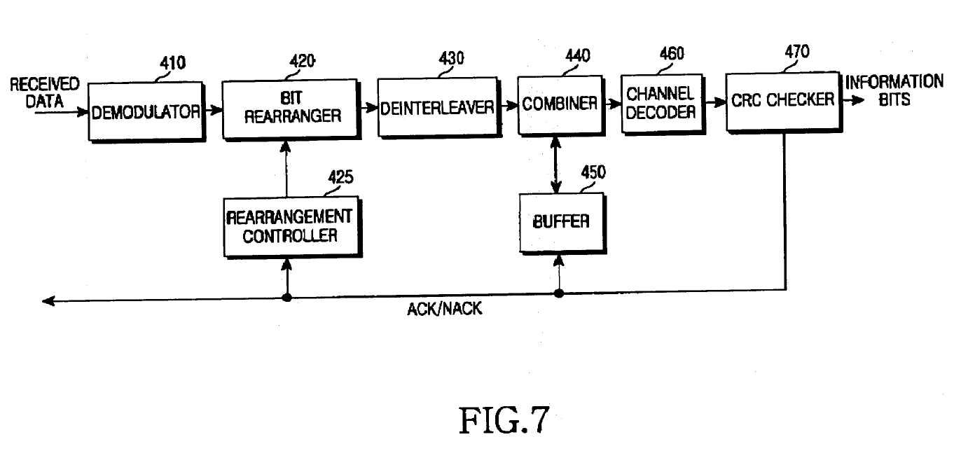

FIG. 7 is a block diagram of a receiver being the counterpart of the transmitter illustrated in FIG. 4 according to an embodiment of the present invention. Referring to FIG. 7, the receiver includes a demodulator 410, a bit rearranger 420, an rearrangement controller 425, a deinterleaver 430, a combiner 440, a buffer 450, a channel decoder 460, and a CRC checker 470.

In operation, the demodulator 410 demodulates data received from the transmitter in a demodulation method corresponding to the modulation scheme used in the modulator 260. The bit rearranger 420 rearranges demodulated data on a modulation symbol basis in a rearrangement method corresponding to that used in the bit rearranger 250 of the transmitter. The bit rearrangement will be described later in more detail.

The deinterleaver 430 deinterleaves the output of the bit rearranger 420 in a deinterleaving method corresponding to the interleaving in the interleaver 240 of the transmitter.

The combiner 440 combines the current received coded bits of a packet with the coded bits of the same packet accumulated in the buffer 450. If there are no coded bits of the same packet in the buffer 450, that is, in the case of an initial transmission, the combiner 440 simply outputs the current coded bits and simultaneously stores them in the buffer 450.

The channel decoder 460 recovers the coded bits received from the combiner 440 by decoding them in a predetermined decoding method, turbo decoding herein corresponding to the coding method in the channel encoder 220 of the transmitter.

The CRC checker 470 extracts CRC bits from the decoded information bits on a packet basis and determines whether the packet has errors using the extracted CRC bits. The error check result is delivered to a reception controller (not shown) in an upper layer. The reception controller processes the packet if the packet has no errors and transmits an ACK (Acknowledgement) signal to the transmitter. On the contrary, if the packet has errors, the reception controller transmits an NACK (Non-Acknowledgement) signal to the transmitter, requesting a retransmission of the packet.

If the ACK signal is transmitted to the transmitter, the buffer 450 is initialized by deleting the coded bits of the corresponding packet. If the NACK signal is transmitted to the transmitter, the coded bits of the packet remain in the buffer 450. The rearrangement controller 425 counts transmissions of the NACK signal to determine the sequence number of the next retransmission and correspondingly control the bit rearranger 420.

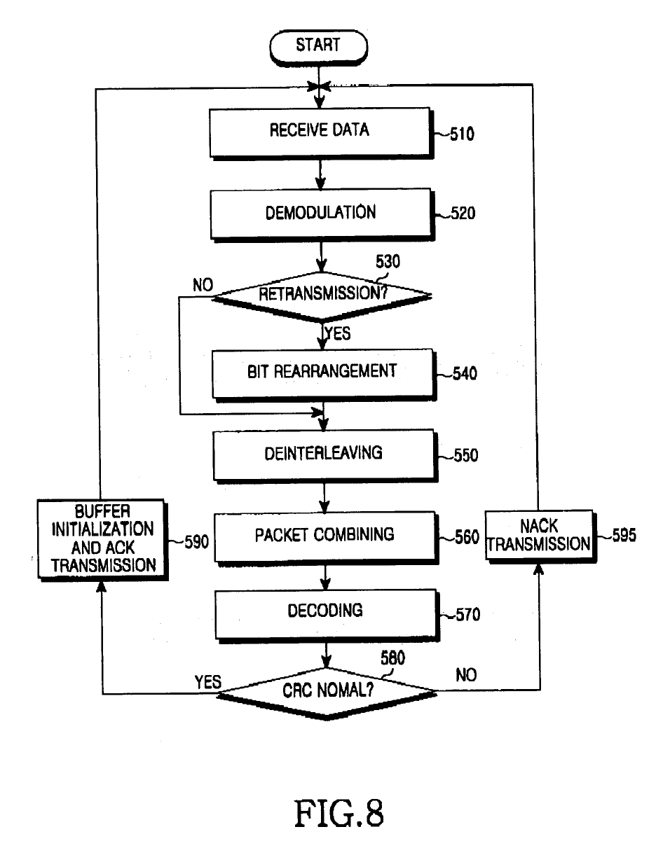

FIG. 8 is a flowchart illustrating the operation of the receiver according to the embodiment of the present invention. Referring to FIG. 8, upon receipt of data on a radio transport channel in step 510, the demodulator 410 recovers in step 520 coded bits by demodulating the received data on a modulation symbol basis in a demodulation method corresponding to a modulation scheme preset between the receiver and the transmitter. In step 530, the rearrangement controller 425 determines whether the coded bits are an initial transmission packet or a retransmission packet according to the count of NACK occurrences for the packet.

In the case of retransmission, the rearrangement controller 425 controls the bit rearranger 420 to rearrange the coded bits on a modulation symbol basis in step 540. On the other hand, in the case of initial transmission, a negative result in step 530, the rearrangement controller 425 causes the coded bits to bypass the bit rearranger 420.

The deinterleaver 430 deinterleaves the output of the bit rearranger 420 in step 550 and, if required, the combiner 440 combines the interleaved bits with the coded bits of the same packet accumulated in the buffer 450 in step 560. In step 570, the channel decoder 460 decodes the combined bits in a decoding method preset between the receiver and the transmitter and outputs the original information bits.

The CRC checker 470 extracts CRC bits from the decoded information bits on a packet basis and reports a CRC check result to the upper layer in step 580. If the packet has no errors, the buffer 450 is initialized and an ACK signal is transmitted to the transmitter in step 590. Then the packet is processed in the upper layer. On the contrary, if the packet has errors, the coded bits stored in the buffer 450 are preserved and an NACK signal requesting a retransmission of the packet is transmitted to the transmitter in step 595.

Packet retransmission in CC, PIR and FIR will be described below. The following description is made with the appreciation that 16QAM and ½ are used in the example as a modulation scheme and a coding rate, and the puncturing pattern P₁ is used for CC and PIR.

1. Packet Retransmission in CC

In operation, the CRC adder 210 adds CRC bits to intended data on a packet basis in the transmitter illustrated in FIG. 4. The channel encoder 220 encodes the data received from the CRC adder 210 at a coding rate predetermined between the transmitter and the receiver.

The operation of the channel encoder 220 will be described in more detail referring to FIG. 5. The data including the CRC bits is output as a systematic bit frame X, and at the same time is fed to the first constituent encoder 224. The first constituent encoder 224 encodes the data to different parity bit frames Y1 and Y2. The internal interleaver 222 interleaves the data and outputs the interleaved data as another systematic bit frame X′. The second constituent encoder 226 encodes the systematic bit frame X′ to two different parity bit frames Z1 and Z2.

The puncturer 228 outputs the coded bits containing systematic bits and parity bits by puncturing the systematic bit frames X and X′ and the parity bit frames Y1, Y2, Z1 and Z2 at a desired coding rate in a predetermined puncturing pattern. As described before, if CC is adopted as the HARQ technique, the same puncturing pattern is used at initial transmission and retransmission, which implies that the same bits are transmitted at initial transmission and retransmission. The puncturing pattern is stored in the puncturer 228 or provided from the controller 270. The latter case is applied in FIG. 5. The puncturing pattern is preset between the transmitter and the receiver.

The rate controller 230 matches the rate of the coded bits received from the channel encoder 220. The interleaver 240 interleaves the rate-matched bits in an interleaving rule preset between the transmitter and the receiver. The bit rearranger 250 rearranges the interleaved bits under the control of the rearrangement controller 255. The modulator 260 maps the rearranged bits to specific symbols and transmits them to the receiver.

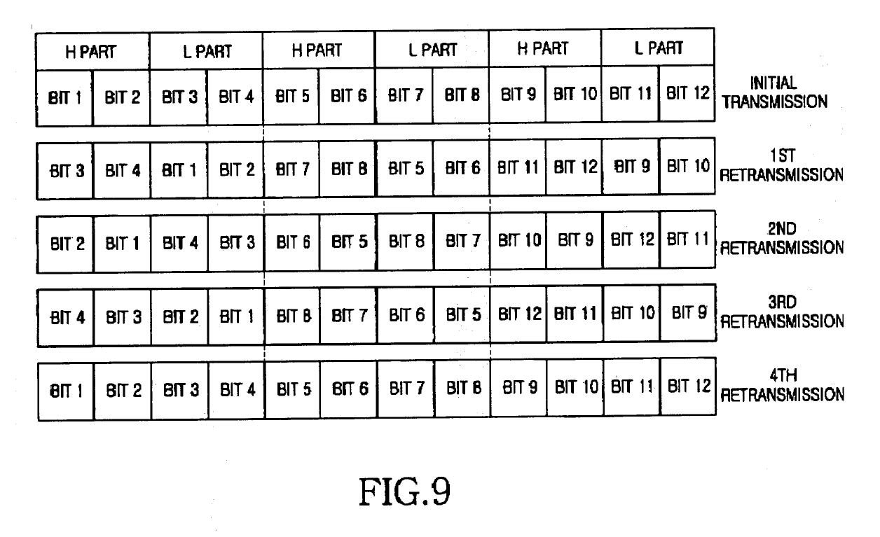

Bit rearrangement will be described in more detail with reference to FIG. 9. FIG. 9 illustrates original bits and their rearrangements in 16QAM. Four coded bits [i1, q1, i2, q2] are mapped to a modulation symbol in a reliability pattern [H, H, L, L]. i1 and i2 are bits transmitted on an I channel and q1 and q2 are bits transmitted on a Q channel. H and L denote a high-reliability part and a low-reliability part, respectively. Coded bits 1, 2, 5, 6, 9 and 10 are mapped to have a high reliability and coded bits 3, 4, 7, 8, 11 and 12, to have a low reliability in modulation symbols at an initial transmission.

At a first retransmission, initially transmitted coded bits are rearranged in their mapping to modulation symbols such that high-reliability bits are exchanged with low-reliability bits. Thus the resulting rearranged coded bits are [i2, q2, i1, q1]. The coded bits 1, 2, 5, 6, 9 and 10 with high reliability at an initial transmission are retransmitted with low reliability. On the contrary, the coded bits 3, 4, 7, 8, 11, and 12 transmitted with low reliability at the initial transmission are retransmitted with high reliability at retransmission.

At a second retransmission, the coded bits are rearranged in their mapping to modulation symbols such that the I-channel bits and the Q-channel bits are exchanged with each other. Thus the resulting rearranged coded bits are [q1, i1, q2, i2]. That is, I-channel bits and Q-channel bits at the initial transmission become Q-channel bits and I-channel bits respectively at the second retransmission. The exchange of I and Q channels effects I-Q channel phase diversity.

At a third retransmission, the coded bits are rearranged in their mapping to modulation symbols such that the high-reliability bits are exchanged with the low-reliability bits and then the I-channel bits are exchanged with the Q-channel bits. Thus the resulting rearranged coded bits are [q2, i2, q1, i1]. That is, the I-channel bits with high probability at the initial transmission become Q-channel bits with low probability at the third retransmission.

From a fourth retransmission on, the above rearrangement procedure is repeated, beginning with the pattern of the initial transmission.

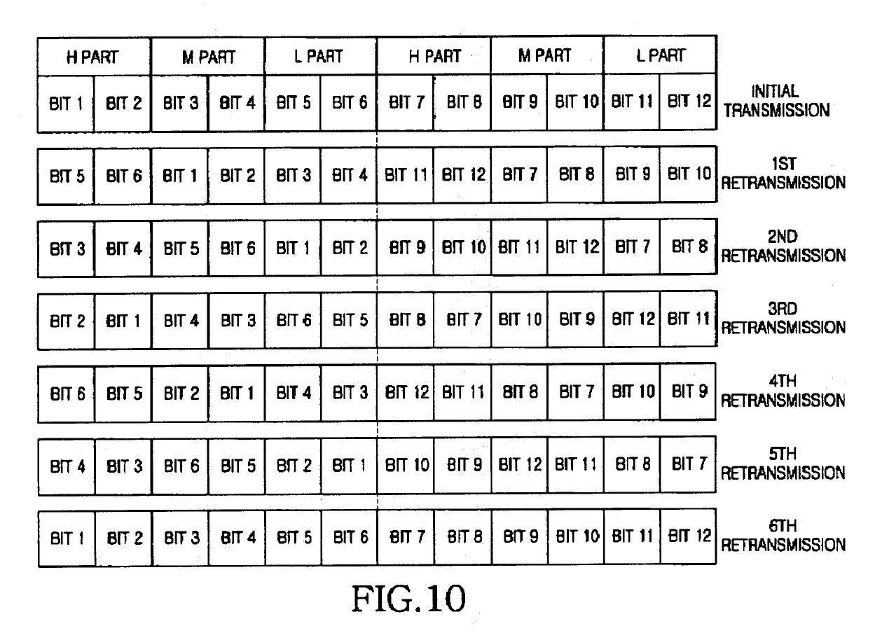

FIG. 10 illustrates original bits and their rearrangements in 64QAM. 6 coded bits [i1, q1, i2, q2, i3, q3] are mapped to a modulation symbol in a reliability pattern [H, H, M, M L, L]. i1, i2 and i3 are bits transmitted on an I channel and q1, q2 and q3 are bits transmitted on a Q channel. H, M and L denote a high-reliability part, a medium-reliability part and a low-reliability part, respectively. Two upper bits of each modulation symbol 1, 2, 7 and 8 have a high reliability, two middle bits of each modulation symbol, 3, 4, 9 and 10 have a medium reliability, and two lower bits of each modulation symbol, 5, 6, 11 and 12 have a low reliability at an initial transmission.

At a first retransmission, the initially transmitted coded bits are rearranged by 2-bit right rotation in their mapping to modulation symbols, so that the resulting rearranged coded bits are [i3, q3, i1, q1, i2, q2]. The coded bits 1, 2, 7 and 8 with high reliability at the initial transmission are retransmitted with medium reliability, the coded bits 3, 4, 9 and 10 with medium reliability at the initial transmission are retransmitted with low reliability, and the coded bits 5, 6, 11 and 12 with low reliability at the initial transmission are retransmitted with high reliability.

At a second retransmission, the coded bits are rearranged by 4-bit right rotation in mapping to modulation symbols, so that the resulting rearranged coded bits are [i2, q2, i3, q3, i1, q1]. Thus when coded bits are transmitted three times, each pair of same reliability-level bits has the other two reliabilities.

At a third retransmission, the coded bits are rearranged in mapping to modulation symbols such that the I-channel bits and the Q-channel bits are exchanged with each other. Thus the resulting rearranged coded bits are [q1, i1, q2, i2, q3, i3]. The exchange of I and Q channels effects I-Q channel phase diversity.

At a fourth retransmission, the coded bits are rearranged by 2-bit right rotation and exchange between the I-channel bits and the Q-channel bits in mapping to modulation symbols. Thus the resulting rearranged coded bits for the fourth retransmission are [q3, i3, q1, i1, q2, i2].

At a fifth retransmission, the coded bits are rearranged by 4-bit right rotation and exchange between the I-channel bits and the Q-channel bits in mapping to modulation symbols. Thus the resulting rearranged coded bits for the fourth retransmission are [q2, i2, q3, i3, q1, i1].

From a sixth retransmission on, the above rearrangement procedure is repeated, beginning with the initial transmission pattern.

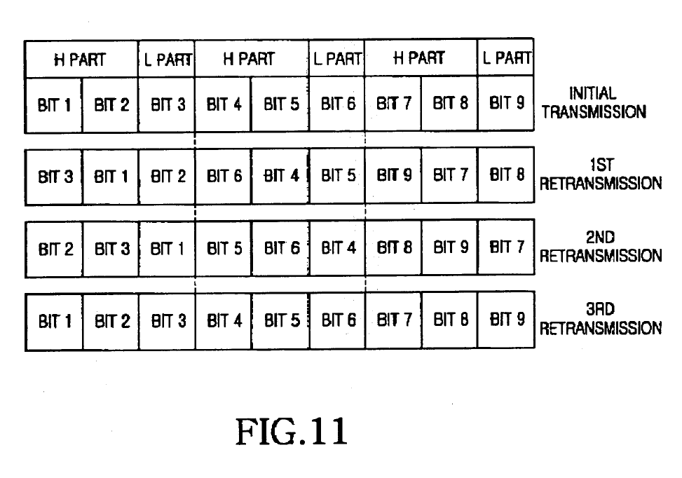

FIG. 11 illustrates original bits and their rearrangements in 8PSK. 3 coded bits [b1, b2, b3] are mapped to a modulation symbol in a reliability pattern [H, H, L]. Two upper bits of each modulation symbol 1, 2, 4, 5, 7 and 8 have a high reliability, and the other one bit of each modulation symbol, 3, 6 and 9 have a low reliability at an initial transmission.

At a first retransmission, the initially transmitted coded bits are rearranged by 1-bit right rotation in mapping to modulation symbols, so that the resulting rearranged coded bits are [b3, b1, b2]. The coded bits 1, 3, 4, 6, 7 and 9 are retransmitted with high reliability, and the coded bits 2, 5 and 8 are retransmitted with low reliability.

At a second retransmission, the coded bits are rearranged by 2-bit right rotation in mapping to modulation symbols, so that the resulting rearranged coded bits are [b2, b3, b1]. The coded bits 2, 3, 5, 6, 8 and 9 are retransmitted with high reliability, and the coded bits 1, 4 and 7 are retransmitted with low reliability.

From a third retransmission on, the above rearrangement procedure is repeated, beginning with the initial transmission pattern.

While it has been described that bit rearrangement is carried out at a retransmission according to the reliability pattern of modulation symbols or according to I and Q channels, they are mere exemplary applications. Therefore, it can be further contemplated as other embodiments that the sequence of rearrangement patterns is changed or part of the rearrangement patterns are used.

Now packet reception in the receiver illustrated in FIG. 7 will be described.

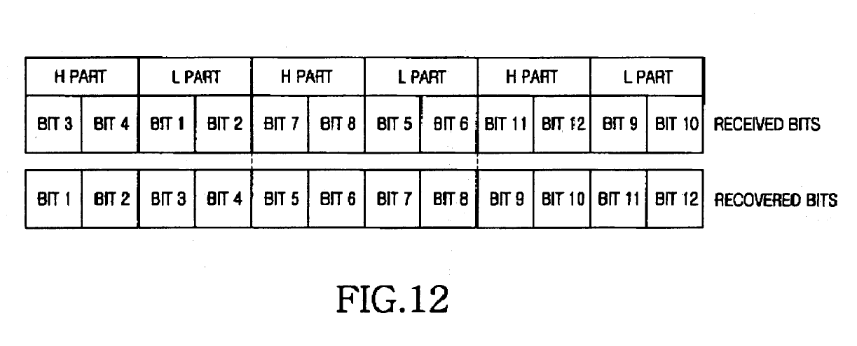

In operation, the demodulator 410 demodulates data received from the transmitter in a demodulation method corresponding to the modulation scheme used in the transmitter. The bit rearranger 420 rearranges the demodulated bits under the control of the rearrangement controller 425. Bit rearrangement of a first-retransmitted frame will be described referring to FIG. 12 when 16QAM is used.

In response to a first NACK signal retransmitted bits, as illustrated in the upper half of FIG. 12, are input to the bit rearranger 420. Since the retransmission bits were rearranged to have a different reliability from that of an initial transmission in the transmitter, the bit rearranger 420, for packet combining, rearranges the received bits in the original order in correspondence to the bit rearrangement of the transmitter, as illustrated in the lower half of FIG. 12.

The deinterleaver 430 deinterleaves the rearranged bits and the combiner 440 combines the initial transmission bits stored in the buffer 450 with their retransmission bits. If a plurality of retransmissions have occurred, coded bits received at each retransmission are accumulated. As stated before, the coded bits of the same packet are combined.

For combining, the combiner 440 receives previously received coded bits from the buffer 450. The buffer 450 stores them according to an CRC check result in the CRC checker 470. In the case of initial transmission, the combiner 440 stores the coded bits in the buffer 450 and simultaneously feeds them to the channel decoder 460.

The channel decoder 460 recovers information bits by decoding the combined bits in a predetermined decoding method. That is, for the input of systematic bits and parity bits, the channel decoder 460 recovers the systematic bits.

The CRC checker 470 extracts CRC bits from decoded information bits on a packet basis and determines whether the packet has errors based on the CRC bits. If the packet has errors, the CRC checker 470 reports the errors to the upper layer and requests a retransmission of the packet by transmitting an NACK signal to the transmitter. If the packet is free of errors, the CRC checker 470 delivers the information bits to the upper layer and transmits an ACK signal to the transmitter. In this case, the buffer 450 is initialized.

2. Packet Retransmission in PIR

In operation, the CRC adder 210 adds CRC bits to intended data on a packet-by-packet basis in the transmitter illustrated in FIG. 4. The channel encoder 220 encodes the data received from the CRC adder 210 at a predetermined coding rate and outputs coded bits including systematic bits and parity bits.

The operation of the channel encoder 220 is the same as that in CC, except that the puncturer 228 uses a different puncturing pattern. In the PIR puncturing pattern, the same systematic bits and different parity bits are transmitted at each transmission.

For example, the puncturing patterns P₁ and P₂ can be alternately used, which is determined by agreement between the transmitter and the receiver.

Rate matching and interleaving are carried out in the same manner as in CC. Yet since different bits can be transmitted at each transmission in PIR, the bit rearranger 420 performs bit rearrangement under the control of the rearrangement controller 255 only when the same bits are retransmitted. The rearrangement controller 255 determines whether the same bits are retransmitted or not according to a puncturing pattern provided to the channel encoder 220. If the same puncturing pattern is used, it is determined that the same bits are retransmitted. In this case, bit rearrangement is carried out in the same manner as described before with reference to FIGS. 9, 10 and 11.

Now packet reception in the receiver illustrated in FIG. 7 will be described.

In operation, the demodulator 410 demodulates data received from the transmitter in a demodulation method corresponding to the modulation scheme used in the transmitter.

The rearrangement controller 425 determines whether the coded bits are retransmitted and, if so, determines the sequence number of the retransmission additionally, the rearrangement controller 425 controls the bit rearranger 420 according to the determination result. The bit rearranger 420 rearranges the demodulated bits in correspondence to the bit rearrangement in the transmitter. In PIR, the same systematic bits are transmitted irrespective of initial transmission and retransmission, but different parity bits are transmitted at each transmission. Therefore, the rearrangement controller 420 activates the bit rearranger 420 only when the same bits are re-received.

For example, if the same bits are transmitted at an initial transmission and a second retransmission, and first-retransmitted bits are still transmitted at a third retransmission, the bit rearranger 420 performs bit rearrangement only at the second and third retransmissions. It is determined according to a puncturing pattern whether the same bits are retransmitted. That is, only when the same puncturing pattern is used, bit rearrangement is carried out.

The deinterleaver 430 deinterleaves the rearranged bits and the combiner 440 combines the deinterleaved bits with previously received same coded bits. The channel decoder 460 recovers information bits by decoding the output of the combiner 440.

3. Packet Retransmission in FIR

In operation, the CRC adder 210 adds CRC bits to intended data on a packet-by-packet basis in the transmitter illustrated in FIG. 4. The channel encoder 220 outputs systematic bits and parity bits in the puncturing pattern PI or P₂ at initial transmission, and outputs only parity bits in one of puncturing patterns at retransmission, as illustrated below. The puncturing patterns used in the puncturer 228 are preset between the transmitter and the receiver.

$$\begin{matrix}{P}_{3} = [ \begin{matrix}0 & 0 \\ 1 & 0 \\ 1 & 0 \\ 0 & 0 \\ 0 & 1 \\ 0 & 1\end{matrix} ] & ( 3 ) \\ {P}_{4} = [ \begin{matrix}0 & 0 \\ 0 & 1 \\ 0 & 1 \\ 0 & 0 \\ 1 & 0 \\ 1 & 0\end{matrix} ] & ( 4 )\end{matrix}$$

If the channel encoder 220 uses the puncturing pattern P₃, it outputs coded bits Y1, Y2, Z1 and Z2.

The rate matcher 230 matches the data rate of the coded bits and the interleaver 240 interleaves the rate-matched bits. The modulator 260 modulates the interleaved bits in a predetermined scheme and transmits the modulation symbols to the receiver.

When FIR is used as the HARQ technique, systematic bits are transmitted only at an initial transmission. At each retransmission, only parity bits are transmitted and thus bit rearrangement is considered after a first retransmission. That is, bit rearrangement is performed on the same parity bits because transmission of all parity bit frames with a uniform reliability improves decoding performance over transmission of specific parity bit frames with reliability. Whether to perform bit rearrangement is determined according to a puncturing pattern, as in the CC method. That is, bit rearrangement is available only when the same puncturing pattern is used.

For example, if the puncturing pattern P₃ is used at a first retransmission, the coded bits are Y2, Y2, Z2 and Z2, without rearrangement. Here, bits Y1 and Y2 are mapped to have a high reliability and bits Z1 and Z2 are mapped to have a low reliability. Then when the same puncturing pattern is used again, the coded bits are rearranged in a different rearrangement pattern as described before with reference to FIGS. 9, 10 and 11.

Now packet reception in the receiver illustrated in FIG. 7 will be described.

In operation, the demodulator 410 demodulates data received from the transmitter in a demodulation method corresponding to the modulation scheme used in the transmitter.

The rearrangement controller 425 determines whether the coded bits are retransmitted, and, if so, determines the sequence number of the retransmission the rearrangement controller 425 controls the bit rearranger 420 according to the determination result. The bit rearranger 420 rearranges the demodulated bits corresponding to the bit rearrangement in the transmitter.

In FIR, bit rearrangement is available only if the same coded bits are retransmitted. Therefore, the combiner 440 combines retransmitted bits P with the same bits P in the same manner as in CC. Channel decoding of the output of the combiner 440 is performed in the manner as described before and thus its description is not provided here.

While it has been described that the bit rearranger and the interleaver are separate, they may be integrated. The interleaver stores input bits according to an interleaving rule. Upon generation of a memory address to be read, the interleaver reads a bit at the address. When the interleaver is integrated with the bit rearranger, the integrated interleaver generates as many read addresses as included in one modulation symbol according to a modulation scheme, and rearranges the memory addresses according to a rearrangement pattern. Then, bits are output from the memory according to the addresses.

For example, if write addresses generated to store an 8-bit frame in 16QAM are 100, 101, 102, 103, 104, 105, 106, 107 and read addresses are 104, 107, 100, 105, 103, 106, 101, 102, the integrated interleaver operates as follows.

At an initial transmission, the integrated interleaver reads bits from the memory according to the read addresses in the above order. At a first retransmission, the read addresses are rearranged in units of four bits of [100, 105, 104, 107] and [101, 102, 103, 106]. Then, the memory outputs bits in the order of the rearranged read addresses. From a second retransmission on, the order of read addresses are altered according to the rearrangement patterns illustrated in FIG. 9.

Similarly, the bit rearranger can be integrated with the deinterleaver in the receiver and the integrated bit rearranger-deinterleaver operates corresponding to the integrated bit rearranger-interleaver in the transmitter.

In accordance with the present invention as described above, coded bits are rearranged in their mapping to a modulation symbol at a retransmission. As a result, the LLRs (Log Likelihood Ratios) of bits input to a turbo decoder at a receiver become uniform and thus excellent decoding efficiency can be achieved.

The present invention can be applied to any of transmitters and receivers for wired and wireless communication and readily implemented with the use of a simple bit rearranger. Therefore, the overall system performance is improved remarkably without an increase in system complexity, and BER (Bit Error Rate) and FER (Frame Error Rate) are reduced, thereby increasing throughput.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of retransmitting coded bits in a transmitter having an encoder for encoding a packet data stream and outputting coded bits and a modulator for mapping the coded bits to modulation symbols in a CDMA (Code Division Multiple Access) mobile communication system, comprising the steps of:
rearranging the coded bits in a predetermined rearrangement pattern upon a retransmission request by a receiver;
mapping the rearranged bits to modulation symbols; and
transmitting the modulation symbols to the receiver.

2. The method of claim 1, wherein the rearrangement pattern is determined according to the sequence number of the retransmission request from the receiver.

3. The method of claim 1, wherein each modulation symbol is divided into a first part having a high reliability and a second part having a low reliability, and in the rearranging step coded bits mapped to the first part are exchanged with coded bits mapped to the second part.

4. The method of claim 1, wherein each modulation symbol is divided into a first part having a high reliability, a second part having a low reliability, and a third part having a reliability between the first and second parts, and in the rearranging step coded bits mapped to the first part, coded bits mapped to the second part, and coded bits mapped to the third part are rearranged such that the reliability of the coded bits at initial transmission is different from the reliability of the coded bits at retransmission.

5. The method of claim 1, wherein each modulation symbol is divided into a first part for transmission on an I (In Phase) channel and a second part for transmission on a Q (Quadrature Phase) channel, and in the rearranging step coded bits mapped to the first part are exchanged with coded bits mapped to the second part.

6. The method of claim 1, wherein the rearranged coded bits are mapped to modulation symbols in one of 8PSK (Phase Shift Keying), 16QAM (Quadrature Amplitude Modulation), and 64QAM.

7. A method of retransmitting coded bits in a transmitter having an encoder for encoding a packet data stream and outputting coded bits and a modulator for mapping the coded bits to modulation symbols in 16QAM in a CDMA (Code Division Multiple Access) mobile communication system, comprising the steps of:
rearranging the coded bits by exchanging coded bits mapped to a high reliability part with coded bits mapped to a low reliability part, upon a retransmission request by a receiver after an initial transmission; and
mapping the rearranged bits to modulation symbols in 16QAM.

8. The method of claim 7, further comprising the step of rearranging the coded bits by exchanging coded bits mapped to an I (In Phase) channel part with coded bits mapped to a Q (Quadrature Phase) channel part, upon a second retransmission request by the receiver.

9. The method of claim 7, further comprising the step of rearranging the coded bits by exchanging coded bits mapped to a high reliability part with coded bits mapped to a low reliability part and exchanging coded bits mapped to the I channel part with coded bits mapped to the Q channel part, upon a third retransmission request by the receiver.

10. The method of claim 8, further comprising the step of rearranging the coded bits by exchanging coded bits mapped to the high reliability part with coded bits mapped to the low reliability part and exchanging coded bits mapped to the I channel part with coded bits mapped to the Q channel part, upon a fourth retransmission request by the receiver.

11. A method of retransmitting coded bits in a transmitter having an encoder for encoding a packet data stream and outputting coded bits and a modulator for mapping the coded bits to modulation symbols in 64QAM in a CDMA (Code Division Multiple Access) mobile communication system, comprising the steps of:
rearranging the coded bits by exchanging coded bits mapped to a first part having a high reliability, coded bits mapped to a second part having a low reliability, and coded bits mapped to a third part having a reliability between the first and second reliabilities such that the reliability of the coded bits at initial transmission is different from the reliability at retransmission, upon a retransmission request by a receiver; and
mapping the rearranged bits to modulation symbols in 64QAM.

12. The method of claim 11, wherein upon a retransmission request by the receiver for, the coded bits are rearranged in the rearranging step by replacing the coded bits mapped to the third part with the coded bits mapped to the first part, replacing the coded bits mapped to the first part with the coded bits mapped to the second part, and replacing the coded bits mapped to the second part with the coded bits mapped to the third part.

13. The method of claim 12, wherein upon another retransmission request by the receiver another retransmission of the coded bits, the coded bits are rearranged by replacing the coded bits mapped to the second part with the coded bits mapped to the first part, replacing the coded bits mapped to the third part with the coded bits mapped to the second part, and replacing the coded bits mapped to the first part with the coded bits mapped to the third part.

14. The method of claim 11, further comprising the step of rearranging the coded bits by exchanging coded bits mapped to an I channel part with coded bits mapped to a Q channel part, upon another retransmission request by the receiver.

15. The method of claim 11, further comprising the step of rearranging the coded bits by exchanging the coded bits mapped to the first part, the coded bits mapped to the second part, and the coded bits mapped to the third part having a reliability between the first and second reliabilities such that the reliability of the coded bits at initial transmission is different from the reliability at retransmission upon a retransmission request by a receiver, and exchanging coded bits mapped to the I channel part with coded bits mapped to the Q channel part, upon another retransmission request by the receiver.

16. The method of claim 15, further comprising the step of rearranging the rearranged coded bits by replacing the coded bits mapped to the third part with the coded bits mapped to the first part, replacing the coded bits mapped to the first part with the coded bits mapped to the second part, and replacing the coded bits mapped to the second part with the coded bits mapped to the third part, and exchanging coded bits mapped to the I channel part with coded bits mapped to the Q channel part, upon another retransmission request by the receiver.

17. The method of claim 15, further comprising the step of rearranging the rearranged coded bits by replacing the coded bits mapped to the second part with the coded bits mapped to the first part, replacing the coded bits mapped to the third part with the coded bits mapped to the second part, and replacing the coded bits mapped to the first part with the coded bits mapped to the third part, and exchanging coded bits mapped to the I channel part with coded bits mapped to the Q channel part, upon another retransmission request by the receiver.

18. An apparatus for retransmitting coded bits in a transmitter having an encoder for encoding a packet data stream and outputting coded bits and a modulator for mapping the coded bits to modulation symbols in a mobile communication system, comprising:
a bit rearranger for rearranging the coded bits in a predetermined rearrangement pattern upon a retransmission request by the receiver; and
a modulator for mapping the rearranged bits to modulation symbols.

19. The apparatus of claim 18, wherein the bit rearranger determines the rearrangement pattern according to the sequence number of the retransmission request from the receiver.

20. The apparatus of claim 18, wherein each modulation symbol is divided into a first part having a high reliability and a second part having a low reliability, and the bit rearranger rearranges the coded bits by exchanging coded bits mapped to the first part with coded bits mapped to the second part.

21. The apparatus of claim 18, wherein each modulation symbol is divided into a first part having a high reliability, a second part having a low reliability, and a third part having a reliability between the first and second parts, and the bit rearranger rearranges the coded bits by exchanging coded bits mapped to the first part, coded bits mapped to the second part, and coded bits mapped to the third part having a reliability between the first and second reliabilities such that the reliability of the coded bits at initial transmission is different from the reliability at retransmission, upon a retransmission request by a receiver.

22. The apparatus of claim 18, wherein each modulation symbol is divided into a first part for transmission on an I (In Phase) channel and a second part for transmission on a Q (Quadrature Phase) channel, and the bit rearranger rearranges the coded bits by exchanging coded bits mapped to the first part with coded bits mapped to the second part.

23. The apparatus of claim 18, wherein the modulator maps the rearranged bits to modulation symbols in one of 8PSK (Phase Shift Keying), 16QAM (Quadrature Amplitude Modulation), and 64QAM.

24. An apparatus for retransmitting coded bits in a transmitter of a mobile communication system, comprising:
a channel encoder for generating coded bits by encoding input data at a predetermined coding rate;
an interleaver for interleaving the coded bits in a predetermined interleaving rule;
a bit rearranger for rearranging the interleaved bits in a predetermined rearrangement pattern upon a retransmission request by the receiver; and
a modulator for mapping the rearranged bits to modulation symbols in a predetermined modulation scheme.

25. An apparatus for retransmitting coded bits in a transmitter of a mobile communication system, comprising:
a channel encoder for generating coded bits by encoding input data at a predetermined coding rate;
an interleaver for interleaving the coded bits in a predetermined interleaving rule and rearranging the interleaved bits in a predetermined rearrangement pattern upon a retransmission request by the receiver; and
a modulator for mapping the rearranged bits to modulation symbols in a predetermined modulation scheme.

26. A method of receiving rearranged coded bits in a mobile communication system where a transmitter rearranges initially transmitted coded bits upon a retransmission request by a receiver, comprising the steps of:
demodulating data received for a transmitted retransmission request and outputting coded bits;
rearranging the coded bits in a predetermined rearrangement pattern corresponding to a rearrangement pattern used in the transmitter; and
decoding the rearranged coded bits.

27. The method of claim 26, wherein the coded bits are rearranged into an original order before the rearrangement in the transmitter.

28. The method of claim 26, wherein in the decoding step the rearranged bits are combined with previously received corresponding coded bits.

29. The method of claim 26, wherein in the demodulation step the received data is symbol-demapped in one of 8PSK (Phase Shift Keying), 16QAM (Quadrature Amplitude Modulation), and 64QAM.

30. An apparatus for receiving rearranged coded bits in a mobile communication system where a transmitter rearranges initially transmitted coded bits upon a retransmission request by a receiver for, comprising:
a demodulator for demodulating data received as a result of a transmitted retransmission request and outputting coded bits;
a bit rearranger for rearranging the coded bits in a predetermined rearrangement pattern corresponding to a rearrangement pattern used in the transmitter; and
a channel decoder for decoding the rearranged coded bits.

31. The apparatus of claim 30, wherein the bit rearranger rearranges the coded bits into an order existing before the rearrangement in the transmitter.

32. The apparatus of claim 30, further comprising a combiner for combining the rearranged bits with previously received corresponding coded bits and feeding the combined bits to the channel decoder.

33. The apparatus of claim 30, further comprising:
an error checker for extracting error check bits from information bits decoded by the channel decoder on a packet-by-packet basis and determining whether the information bits have errors according to the extracted error check bits; and
a controller for requesting a retransmission of the coded bits from the transmitter if the information bits have errors.

34. The apparatus of claim 30, wherein the demodulator symbol-demaps the received data in one of 8PSK (Phase Shift Keying), 16QAM (Quadrature Amplitude Modulation), and 64QAM.

35. An apparatus for receiving rearranged coded bits in a mobile communication system where a transmitter rearranges initially transmitted coded bits upon a retransmission request by a receiver for, comprising:
a demodulator for demodulating data received as a result of a transmitted retransmission request in a predetermined modulation scheme and outputting coded bits;
a bit rearranger for rearranging the coded bits in a predetermined rearrangement pattern corresponding to a rearrangement pattern used in the transmitter;
a deinterleaver for deinterleaving the rearranged bits in a deinterleaving rule corresponding to an interleaving rule used in the transmitter;
a combiner for combining the deinterleaved bits with previously received corresponding coded bits;
a channel decoder for decoding the combined bits;
an error checker for extracting error check bits from information bits decoded by the channel decoder on a packet-by-packet basis and determining whether the information bits have errors according to the extracted error check bits; and
a controller for requesting a retransmission of the coded bits from the transmitter if the information bits have errors.

36. An apparatus for receiving rearranged coded bits in a mobile communication system where a transmitter rearranges initially transmitted coded bits upon a retransmission request by a receiver for a retransmission of the coded bits, comprising:
a demodulator for demodulating data received as a result of a transmitted retransmission request in a predetermined modulation scheme and outputting coded bits;
a deinterleaver for deinterleaving the coded bits according to a deinterleaving rule corresponding to an interleaving rule used in the transmitter and rearranging the deinterleaved bits in a predetermined rearrangement pattern corresponding to a rearrangement pattern used in the transmitter;
a combiner for combining the deinterleaved bits with previously received corresponding coded bits;
a channel decoder for decoding the combined bits;
an error checker for extracting error check bits from information bits decoded by the channel decoder on a packet-by-packet basis and determining whether the information bits have errors according to the extracted error check bits; and
a controller for requesting a retransmission of the coded bits from the transmitter if the information bits have errors.
